(19) United States
(12) Patent Application Publication
(10) Pub. No.: US 2015/0058243 A1
(43) Pub. Date: Feb. 26, 2015

(54) Compliance Gap Assessment and Improvement Tool

(71) Applicants: The Major Group Inc., Virginia Beach, VA (US); Software Performance Group Inc., Washington, DC (US)

(72) Inventor: Chad Cloud, Springfield, VA (US)

(73) Assignees: The Major Group Inc., Virginia Beach, VA (US); Software Performance Group Inc., Washington, DC (US)

(21) Appl. No.: 14/287,617

(22) Filed: May 27, 2014

Related U.S. Application Data
(60) Provisional application No. 61/827,183, filed on May 24, 2013.

(51) Int. Cl. G06Q 50/20; G06Q 10/00

(52) U.S. Cl. CPC G06Q 50/2057; G06Q 10/00
USPC 705/328

(57) ABSTRACT

A method of assisting a person, entity, or user in achieving a target, which includes a new position, status, certification, or identifiable goal. The method includes three independent functions, wherein an initial common operations, attribute and training presentation function, and alternative target presentation function are performed. The invention includes processes that generate a single value assessment score of a user, inform the user of attributes associated with the target, provide training programs related to important attributes of the target, and provide the user with suggestions of similar targets based on the attributes and response levels of the user.

This application claims the benefit of U.S. Provisional Application No. 61/827,183, filed May 24, 2013, which is hereby incorporated by reference in its entirety as if fully set forth herein.

### SUMMARY OF THE INVENTION

The invention addresses the general problem of assisting a person or entity in achieving a new position, status, or certification. One way to do that is to determine appropriate ameliorative steps that are required to bridge the gap between the levels of achievement a given person or entity currently has and the levels of achievement that are required of a person or entity that is compliant with externally specified requirements for the desired position, status, or certification. Achievement is measured by the levels of performance of the person or entity with respect to each of several attributes that are important for the desired position, status, or certification. A prime example is the need for a tool to assist persons who want to apply for a new job. They would benefit from assistance in determining how close their own attribute achievement levels are to the attribute achievement levels that are required of persons who occupy that job. Another interest is to provide job applicants with access to training resources that might help them close the gap between their achievement levels and the required achievement levels on each attribute that is important for the job they originally sought. Another interest is to give users suggestions for jobs similar to the one they originally sought but for which their current attribute achievement levels may be sufficient or more nearly sufficient.

The invention includes the following processes that:

(1) generate a single value overall Assessment Score of the person or entity;

(2) inform users or entities on the important Attributes associated with the new position, status, or certification they want to apply for, the standard levels of achievement in those Attributes, and their own achievement levels in those Attributes;

(3) provide training programs that are geared to the important Attributes of the new position, status, or certification sought by the users or entities; and

(4) provide suggestions for similar new positions, status, or certifications the user or entity may consider given their current achievement levels.

The process may reside on a general purpose computer or in a specialized machine designed specifically for the purpose of enabling the process. For either case, the invention is referred to as the “Tool.”

A new position, career, status, or certification, or similarly identifiable goals are referred to as the Target, and any collection of Targets as a Functional Regime. The structure of the Tool is independent of the Functional Regime.

The Tool has access to a Database that contains at least the following elements associated with each of one or more available Functional Regimes:
Attributes which may be grouped according to Qualities. Optionally the Database may include the Importance of each Attribute and/or Quality, relative to all the other Attributes and/or Qualities within a given Functional Regime;
a collection of one or more Queries associated with each Attribute, where each Query has a set of possible graded responses ordered from 0 to r, and where r may be different for each Query; and
a collection of Attribute Standards that include the Standard Level to each Query in the range of 0 to r.

The tool also has access to an Improvement Programs database that include:
improvement Methods that are linked to each Query; and
optional Subscriber Organizations that provide each of the Improvement Methods.

The Tool includes a series of operations. The outputs of the operations are defined by the inputs from the previous operations in the series and by accessing the Database, the Improvement Programs database, and user inputs. The operations performed by the Tool depend on which Function the Tool is asked to perform.

These and further and other objects and features of the invention are apparent in the disclosure, which includes the above and ongoing written specification, with the drawings.

### BRIEF DESCRIPTION OF THE DRAWINGS

FIG. 1 is a diagram of an overall gap assessment function

FIG. 2 is a diagram of an attribute and training presentation function

FIG. 3 is a diagram of an alternative target presentation function

### DETAILED DESCRIPTION

The Tool 10 has a database 12 which stores Functional Regimes 14, Targets 15, Attributes 16, Queries 17 and Attribute Standards 18.

### Initial Common Operations

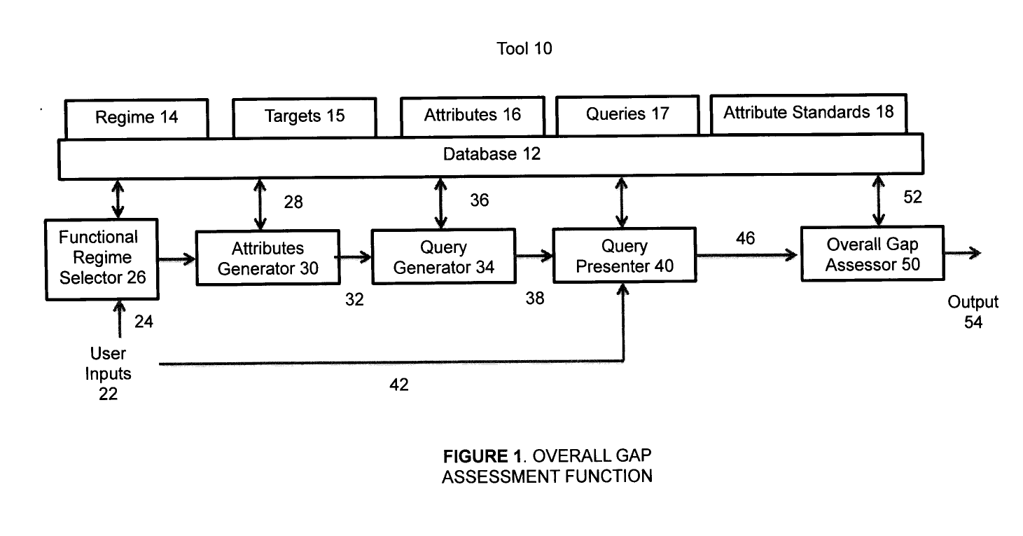

The Initial Operations are common to all Functions in FIGS. 1-3.

A user 22 of the Tool 10 first inputs 24 a proposed Functional Regime and a specific Target in Functional Regime Selector 26. The Tool retrieves 28 the Attributes associated with the proposed Target and passes 32 those Attributes to the Query Generator 34.

The Query Generator 34 accepts 36 the Queries 17 associated with each Attribute 16, and if Importance Data is available for that Attribute the Query Generator selects only those N Queries that rank in the top N values of Importance where N is between 0 and the total number of Queries available for that Attribute. The selected Queries are passed on to the Query Presenter 40.

The Query Presenter 40 thereafter accepts 38 all the Queries from the Query Generator 34 and presents 42 the Queries to the user of the Tool. The Query Generator collects the Response Levels to each Query and passes 46 the Response Levels to the next step.

### Overall Gap Assessment Function

As shown in FIG. 1, after performing the Initial Common Operations, the Overall Gap Assessment Function performs Operation GA4:

In GA4, the Overall Gap Assessor 50 accepts 46 the Response Levels and accesses 52 the Attributes Database 12 for the Attribute Standard Levels 18 associated with each Attribute 16. Then the Overall Gap Assessor 50 automatically computes, for each Attribute, the difference, or “Gap,” between the user's Response Levels and the Standard Levels. The Overall Gap Assessor combines each Gap with the Importance Data for the associated Attribute (if available) and computes a single value 54 that represents the Overall Assessment of Compliance which is presented to the user. One example of this computation is:

(i) computing the numerical difference between the user's Response Levels and the Standard Levels for the results of each Query;

(ii) multiplying the differences by the Importance associated with the Query;

(iii) computing the sum of all the products;

(iv) dividing by the sum of all the Importance values; and

(v) normalizing final value.

Although this is one example, other computational schemes may be used to compute the Overall Gap.

### Attribute and Training Presentation Function

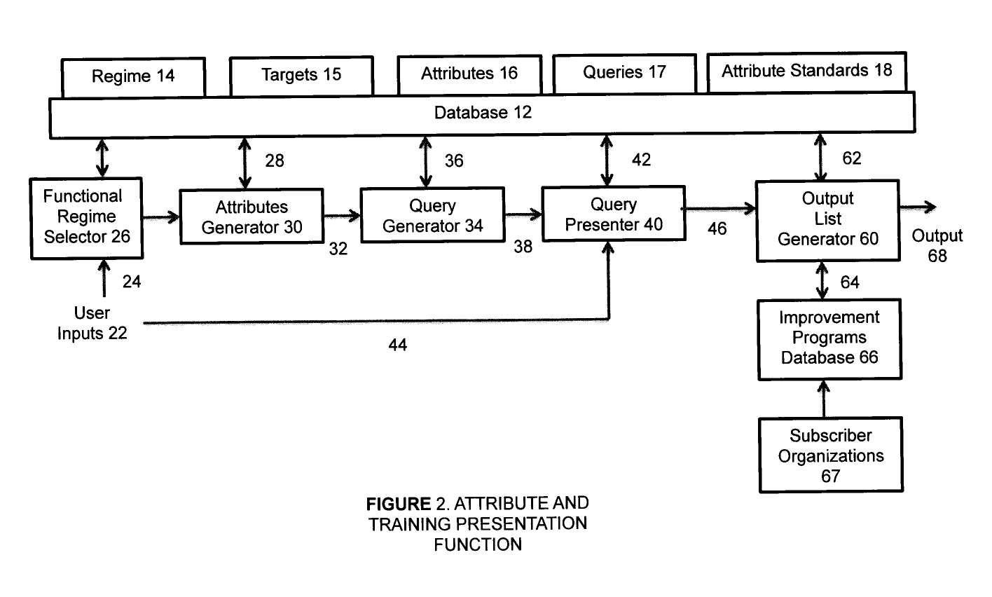

As shown in FIG. 2, after performing the Initial Common Operations, the Attribute and Training Presentation Function performs Operation AT4:

In AT4, the Output List Generator 60 accepts 46 the user's Response Levels and accesses 62, 64 two databases:

(i) the Database 12 to obtain the Attribute Standard Levels 18 and Importance Data associated with each Attribute (if available), and

(ii) the Improvement Programs Database 66 to obtain the Improvement Programs from Subscriber Organizations 67 associated with each Attribute.

The Output List Generator 60 then outputs 68 a list that includes three elements for each Attribute: the user's Response Level (Normalized if needed) for each Attribute, the Standard Levels (Normalized if needed) for each Attribute, and Improvement Programs associated with each Attribute.

### Alternative Target Presentation Function

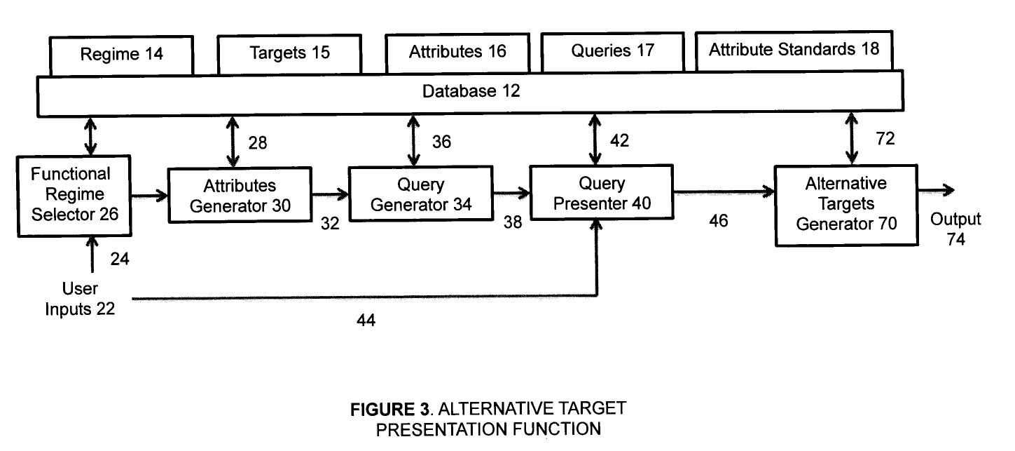

As shown in FIG. 3, after performing the Initial Common Operations the Alternative Target Presentation Function performs Operation AJ4:

In AJ4, the Alternative Targets Generator 70 accepts 46 the user's Response Levels 46 and accesses the Database 12 for the Attribute Standard Levels 18 associated with each Attribute 16. The Alternative Targets Generator 70 then searches 72 the Database 12 for Targets 15 across all Functional Regimes 14 or in a user-specified and selected 26 subset of Functional Regimes, for Targets 15 for which the user's current response level for each associated Attribute 16 would be a closer fit to the Standard Levels 18 for each associated Attribute 16. The Targets 15 found as a result of the search are presented 74 to the user.

### EXAMPLE

In one example, the Functional Regime 14 is chosen from a list of possible careers or job functions and the Targets 15 would be general careers (such as “Programmer”) or specific jobs (such as “Lead Programmer at Company X”). Here Attributes 16 are typically grouped into Qualities such as knowledge, abilities, education level, experience, certifications, and other job-defining qualities. The Attributes 16 are drawn from these Qualities. The Improvement Programs 66 include training programs offered by the Subscriber Organizations 67.

In another example, the Tool's use may be limited to a single Functional Regime, for example, all communications electronics technician jobs. In this case the Tool may be implemented such that the Functional Regime Selector acts merely to accept the Target from the user.

In another example, the Importance Data may be absent, and all Queries are treated of equal importance. In this case the Tool need not do any calculations involving relative importance of Queries associated with Attributes.

These and other features and objects of the invention are described with reference to the drawings.

While the invention has been described with reference to specific embodiments, modifications and variations of the invention may be constructed without departing from the scope of the invention, which is defined in the following claims.

I claim:

1. A method of assisting a person or entity in achieving a new position, status, certification, or identifiable goal, the method comprising performing initial common operations having the steps of:
providing a computer with a first database which stores functional regimes, targets, attributes, queries, and attribute standards, wherein the target is the new position, status, certification, or identifiable goal;
accepting user input of the functional regime and proposed target into a functional regime selector;
receiving the attributes associated with the proposed target, and passing those attributes to a query generator, wherein the query generator accepts the queries associated with each attribute;
selecting and passing queries from the query generator to a query presenter;
presenting the queries to a user with the query presenter; and
collecting response levels with the query generator.

2. The method of claim 1, further comprising providing importance data in the query generator for attributes selected by the query generator, wherein the query generator selects N queries that rank in top N values, wherein N is between 0 and the total number of queries available for a single attribute.

3. The method of claim 2, further comprising performing an overall gap assessment function after performing the initial common operations, wherein the overall gap assessment function includes the steps of:
accepting the response levels of the user from the query generator;
accessing attributes in the first database for attribute standard levels associated with each attribute;
computing for each attribute a difference or gap between the response levels of the user and the standard levels;
combining each difference or gap with the importance data for the associated attribute;
computing a single value that represents overall assessment of compliance; and
presenting the overall assessment of compliance to the user.

4. The method of claim 3, wherein the combining of each difference or gap with the importance data for the associated attribute and computing the single value that represents overall assessment of compliance further comprises multiplying the difference or gap between the response levels of the user and the standard levels by the importance data associated with the query;
computing the sum of all products;
dividing by the sum of all importance data values; and
normalizing the final value.

5. The method of claim 1, further comprising performing an attribute and training presentation function after performing the initial common operations, wherein the attribute and training presentation function includes the steps of:
accepting the response levels of the user from the query generator;
accessing the first database and a second improvement programs database, wherein the first database is accessed to obtain attribute standard levels and importance data associated with each attribute, and the improvement programs database is accessed to obtain improvement programs associated with each attribute; and
outputting a list from an output list generator, wherein the list includes elements for each attribute.

6. The method of claim 5, wherein the list comprises three elements for each attribute, and wherein the three elements are the response level of the user, the standard levels for each attribute, and improvement programs associated with each attribute.

7. The method of claim 6, wherein the response level of the user and the standard levels for each attribute are normalized.

8. The method of claim 6, wherein the improvement programs are training programs related to the attributes of the target sought by the user.

9. The method of claim 1, further comprising performing an alternative target presentation function after performing the initial common operations, wherein the alternative target presentation function includes the steps of:
accepting the response levels of the user from the query generator;
accessing the first database to obtain attribute standard levels associated with each attribute;
searching across all functional regimes in the first database for targets for which the user's current response level for each associated attribute is closer to the standards level for each associated attribute; and
presenting to the user the targets found as a result of the search.

10. The method of claim 9, wherein searching the first database for targets only includes a subset of functional regimes specified by the user.

11. The method of claim 9, further comprising providing to the user suggestions for similar targets based on current achievement levels of the user.

12. A method of assisting a person or entity in achieving a new position, status, certification, or identifiable goal, the method comprising performing initial common operations and an attribute and training presentation function after the initial common operation, the initial common operations having the steps of:
providing a computer with a first database which stores targets, attributes, queries, and attribute standards, wherein the target is the new position, status, certification, or identifiable goal;
accepting user input of the proposed target into a functional regime selector;
receiving the attributes associated with the proposed target, and passing those attributes to a query generator, wherein the query generator accepts the queries associated with each attribute;
selecting and passing queries from the query generator to a query presenter;
presenting the queries to a user with the query presenter; and
collecting response levels with the query generator;
performing the attribute and training presentation function having the steps of:
accepting the response levels of the user from the query generator;
accessing the first database and a second improvement programs database, wherein the first database is accessed to obtain attribute standard levels and importance data associated with each attribute, and the improvement programs database is accessed to obtain improvement programs from subscriber organizations associated with each attribute; and
outputting a list from an output list generator, wherein the list includes elements for each attribute.

13. The method of claim 12, further comprising performing an alternative target presentation function after performing the initial common operations, wherein the alternative target presentation function includes the steps of:
accepting the response levels of the user from the query generator;
accessing the first database to obtain attribute standard levels associated with each attribute;
searching across all targets in the first database for targets for which the user's current response level for each associated attribute is closer to the standards level for each associated attribute; and
presenting to the user the targets found as a result of the search.

14. A method of assisting a person or entity in achieving a new position, status, certification, or identifiable goal, the method comprising performing initial common operations and an alternative target presentation function after the initial common operation, the initial common operations having the steps of:
providing a computer with a first database which stores functional regimes, targets, attributes, queries, and attribute standards, wherein the target is the new position, status, certification, or identifiable goal;
accepting user input of the proposed target into a functional regime selector;
receiving the attributes associated with the proposed target, and passing those attributes to a query generator, wherein the query generator accepts the queries associated with each attribute;
selecting and passing queries from the query generator to a query presenter;
presenting the queries to a user with the query presenter; and
collecting response levels with the query generator;
performing the alternative target presentation function having the steps of:
accepting the response levels of the user from the query generator;
accessing the first database to obtain attribute standard levels associated with each attribute;
searching across all targets in the first database for targets for which the user's current response level for each associated attribute is closer to the standards level for each associated attribute; and
presenting to the user the targets found as a result of the search.

15. The method of claim 14, further comprising performing an attribute and training presentation function after performing the initial common operations, wherein the attribute and training presentation function includes the steps of:
accepting the response levels of the user from the query generator;
accessing the first database and a second improvement programs database, wherein the first database is accessed to obtain attribute standard levels and importance data associated with each attribute, and the improvement programs database is accessed to obtain improvement programs from subscriber organizations associated with each attribute; and
outputting a list from an output list generator, wherein the list includes elements for each attribute.
